(19) United States
(12) Patent Application Publication
(10) Pub. No.: US 2016/0044710 A1
(43) Pub. Date: Feb. 11, 2016

(54) TRANSMISSION/RECEPTION METHOD OF BASE STATION, D2D COMMUNICATION METHOD, AND APPARATUS SUPPORTING THE D2D COMMUNICATION METHOD

(71) Applicant: ELECTRONICS AND TELECOMMUNICATIONS RESEARCH INSTITUTE, Daejeon (KR)

(72) Inventors: Kyoung Seok LEE, Daejeon (KR); Mi Young YUN, Daejeon (KR); Ae-Soon PARK, Daejeon (KR)

(73) Assignee: ELECTRONICS AND TELECOMMUNICATIONS RESEARCH INSTITUTE, Daejeon (KR)

(21) Appl. No.: 14/820,553

(22) Filed: Aug. 6, 2015

(30) Foreign Application Priority Data
Aug. 7, 2014 (KR) 10-2014-0101926
Jul. 17, 2015 (KR) 10-2015-0101677

(51) Int. Cl. H04W 74/00; H04W 52/38; H04W 56/00; H04W 76/04; H04L 29/06; H04W 76/02

(52) U.S. Cl. CPC H04W 74/006; H04L 65/4076; H04W 76/023; H04W 56/0015; H04W 76/046; H04W 52/383; H04W 88/08

(57) ABSTRACT

There is provided a transmission/reception method of a base station in a device to device (D2D) communication environment in which terminals directly communicate with each other. The base station variably sets the transmission power intensity of a downlink signal over time. Furthermore, the base station broadcasts the downlink signal with set transmission power intensity.

### CROSS-REFERENCE TO RELATED APPLICATION

This application claims priority to and the benefit of Korean Patent Application Nos. 10-2014-0101926 and 10-2015-0101677 filed in the Korean Intellectual Property Office on Aug. 7, 2014 and Jul. 17, 2015, the entire contents of which are incorporated herein by reference.

### BACKGROUND OF THE INVENTION

(a) Field of the Invention

The present invention relates to a method of transmitting/receiving, by a base station, signals, a Device to Device (D2D) communication method, that is, direct communication between terminals, and an apparatus supporting the D2D communication method.

(b) Description of the Related Art

In a Long Term Evolution (LTE) system in which a mobile communication network has been constructed based on a base station, research is being carried out in which a direct communication wireless path is set up between adjacent terminals and terminals attempt to perform communication by managing radio resources in a distributed manner.

Direct communication between terminals is communication method in which communication is performed between terminals without the intervention of a base station in such a manner that one terminal wirelessly transmits data and the other terminal directly receives the corresponding data. Direct communication between terminals includes Device to Device (D2D) communication. Hereinafter, for convenience of description, direct communication between terminals is called D2D communication.

D2D communication is performed using radio resources. In mobile communication, a system is constructed based on a base station. A terminal placed in the coverage of a cell constructed through a base station may perform D2D communication under the control of the base station. Furthermore, since D2D communication is directly performed between terminals, a terminal placed out of coverage and not controlled by a base station may also perform D2D communication. Furthermore, a terminal in coverage and a terminal out of coverage may perform D2D communication with each other.

Terminals participating in D2D communication need to maintain time synchronization and frequency synchronization, and there is a need for a synchronization setting and maintenance procedure for maintaining the time synchronization and frequency synchronization.

### SUMMARY OF THE INVENTION

Mobile communication controlled by a base station is performed between the base station and a terminal.

If a terminal is placed within coverage, it performs D2D communication under the control of a mobile communication base station. If a terminal is placed at the boundary of a cell or out of the boundary of the cell, it performs D2D communication in a distributed management manner.

An object of the present invention is to provide a new control structure and method for D2D communication between terminals.

Another object of the present invention is to provide a method and apparatus in which a terminal performs D2D communication if the terminal is placed at the boundary of a cell or out of the boundary of the cell.

Yet another object of the present invention is to provide a control method and apparatus in which a terminal placed at the boundary of a cell does not generate interference with radio resources used by a base station.

In accordance with an exemplary embodiment of the present invention, there is provided the transmission/reception method of a base station in a device to device (D2D) communication environment in which terminals directly communicate with each other. The transmission/reception method includes variably setting the transmission power intensity (strength) of a downlink signal over time and broadcasting the downlink signal with set transmission power intensity.

Variably setting the transmission power intensity may include setting the transmission power intensity of the downlink signal as a first value at a first point of time having a predetermined cycle and setting the transmission power intensity of the downlink signal as a second value greater than the first value at a second point of time having a longer cycle than the first point of time.

Broadcasting the downlink signal may include broadcasting the downlink signal at the first point of time and broadcasting the downlink signal at the second point of time.

Broadcasting the downlink signal at the second point of time may include including an identifier indicative of the base station in the downlink signal.

The downlink signal may include at least one of synchronization information, system information, and control information.

The transmission/reception method may further include instructing a first terminal to change its state to a connected state of an idle state and the connected state when the first terminal receives information about a second terminal operating as a central control device for managing synchronization and resources for the D2D communication and receiving the information about the second terminal from the first terminal in the connected state.

The information about the second terminal may include information about the synchronization time of the second terminal, the terminal identifier of the second terminal, and the number of terminals connected to the second terminal.

The transmission/reception method may further include setting the transmission power intensity and transmission cycle of a synchronization signal transmitted by a first terminal operating as a central control device for managing synchronization and resources for the D2D communication when the first terminal is placed in the cell of the base station.

In accordance with another exemplary embodiment of the present invention, there is provided a D2D communication method in which a first terminal directly communicates with another terminal. The D2D communication method includes broadcasting a first synchronization signal when the first terminal operates as a central control device for managing synchronization and resources for D2D communication, determining a cycle in which a downlink signal is transmitted when the downlink signal is received from a base station, and controlling the broadcasting of the first synchronization signal based on the transmission cycle of the downlink signal.

Controlling the broadcasting of the first synchronization signal may include determining that the first terminal is placed at the boundary of the cell of the base station when the transmission cycle of the downlink signal is longer than a reference cycle, and stopping the broadcasting of the first synchronization signal or reducing the transmission power intensity of the first synchronization signal when the first terminal is placed at the boundary of the cell of the base station.

The downlink signal may include a second synchronization signal broadcasted by the base station.

Controlling the broadcasting of the first synchronization signal may include changing a synchronization time for the broadcasting of the first synchronization signal based on the second synchronization signal when the transmission cycle of the downlink signal is longer than a reference cycle.

Broadcasting the first synchronization signal may include increasing the transmission power intensity of the first synchronization signal and shortening the transmission cycle of the first synchronization signal over time.

The D2D communication method may further include decreasing the transmission power intensity of the first synchronization signal or changing the synchronization time of the first synchronization signal based on a third synchronization signal when the third synchronization signal is received from a cell adjacent to the first terminal or a central control device adjacent to the first terminal.

Changing the synchronization time of the first synchronization signal may include determining the reception intensity of the third synchronization signal and changing the synchronization time of the first synchronization signal based on the third synchronization signal when the reception intensity of the third synchronization signal is greater than a reference value.

The D2D communication method may further include receiving control information including information about a difference between the synchronization time of a first cell and the synchronization time of the first terminal from a second terminal placed within the first cell of the base station and stopping the broadcasting of the first synchronization signal, reducing the transmission power intensity of the first synchronization signal, or changing the synchronization time of the first synchronization signal based on the control information.

The D2D communication method may further include broadcasting a first synchronization channel including synchronization time change information when the synchronization time of the first synchronization signal is changed.

The first synchronization channel may include information about the first synchronization signal corresponding to the first synchronization channel, information about resources for the D2D communication, and information about the number of terminals using the first synchronization signal.

Broadcasting the first synchronization signal may include receiving a request message for checking whether the first terminal is able to operate as a central control device from the base station, transmitting a response message including at least one of pieces of information about mobility, signal intensity, power state, and location of the first terminal to the base station, and operating as a central control device when an indication message is received from the base station.

The D2D communication method may further include setting a signal intensity reference value for cell access as a first value when the first terminal is placed at the boundary of the cell of the base station, and setting the signal intensity reference value as a second value greater than the first value when the first terminal is placed in the cell of the base station.

In accordance with yet another exemplary embodiment of the present invention, there is provided a D2D communication method in which a first terminal directly communicates with another terminal. The D2D communication method includes receiving a first synchronization signal and a first synchronization channel from a first central control device that manages synchronization and resources for the D2D communication and that is different from a base station, obtaining the synchronization for the D2D communication from the first synchronization signal and obtaining the resources for the D2D communication from the first synchronization channel, and transmitting synchronization acquisition information to the first central control device using the resources for the D2D communication.

Transmitting the synchronization acquisition information may include transmitting the synchronization acquisition information including the number of central control devices accessed by the first terminal to the first central control device through at least one of a physical channel, a medium access control (MAC) message, and a radio resource control (RRC) message.

The D2D communication method may further include transmitting information about the synchronization time of the first central control device, information about signal intensity of the first central control device, and information about the number of terminals connected to the first central control device to the base station when the first terminal is placed in a cell of the base station.

### BRIEF DESCRIPTION OF THE DRAWINGS

FIG. 1 is a diagram illustrating a basic communication environment for D2D communication.

FIG. 2 is a diagram illustrating an environment in which terminals placed within the coverage of a base station perform D2D communication in synchronization with a central control device.

FIG. 3 is a diagram illustrating a method of transmitting, by a base station, a signal and a method of transmitting, by a central control device, a signal in accordance with an exemplary embodiment of the present invention.

FIG. 4 is a diagram illustrating a method of transmitting, by a central control device, a signal in accordance with an exemplary embodiment of the present invention.

FIG. 5 is a diagram illustrating the configuration of a base station in accordance with an exemplary embodiment of the present invention.

FIG. 6 is a diagram illustrating the configuration of a terminal in accordance with an exemplary embodiment of the present invention.

FIG. 7 is a diagram illustrating a computer system in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), or user equipment (UE), and may include some or all of the functions of the terminal, MT, MS, AMS, HR-MS, SS, PSS, AT, and UE.

Furthermore, a base station (BS) may refer to an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) functioning as a base station, a relay node (RN) functioning as a base station, an advanced relay station (ARS) functioning as a base station, a high reliability relay station (HR-RS) functioning as a base station, or a small base station [e.g., a femto BS, a home node B (HNB), a home eNodeB (HeNB), a pico BS, a macro BS, or a micro BS], and may include some or all of the functions of the ABS, HR-BS, nodeB, eNodeB, AP, RAS, BTS, MMR-BS, RS, RN, ARS, HR-RS, and small base station.

1. Structure of Radio Resource

In a mobile communication system, a terminal performs communication using radio resources under the control of a base station within coverage constructed through the base station.

In D2D communication, in order to reduce the complexity of a terminal, the frequency of an uplink band that belongs to frequency bandwidth used in mobile communication is used. More specifically, a terminal transmits a signal or channel for D2D communication through uplink, and another terminal receives the signal or channel.

Resources of an uplink band may be divided into resources for cellular communication (e.g., communication between a base station and a terminal) and resources for D2D communication (hereinafter referred to as “D2D communication resources”). More specifically, D2D communication resources may be divided into base station control resources and non-control resources. The base station control resources mean resources allocated to a terminal placed within a cell by a base station. The base station non-control resources mean resources used by a terminal or a central control device without direct control of a base station. A base station may indicate information about the location and range of radio resources through a cell control channel by designating the information as a specific value. A transmission terminal for D2D communication obtains information about the location of base station non-control resources, selects resources in a distributed manner, and transmits D2D communication data (hereinafter referred to as “D2D data”) using the selected resources. A reception terminal for D2D communication periodically receives base station non-control resources and transfers demodulated data to a higher layer if D2D data is demodulated. If a plurality of terminals select the same resources and transmit data, the performance of D2D communication may be deteriorated due to a collision.

A base station may allocate a synchronization signal transmission area required to maintain the synchronization of a terminal. More specifically, the base station may use some of the resources of an uplink band as resources for a synchronization signal.

A base station basically manages and transmits/receives base station control resources, but may also manage and transmit/receive base station non-control resources in a long cycle.

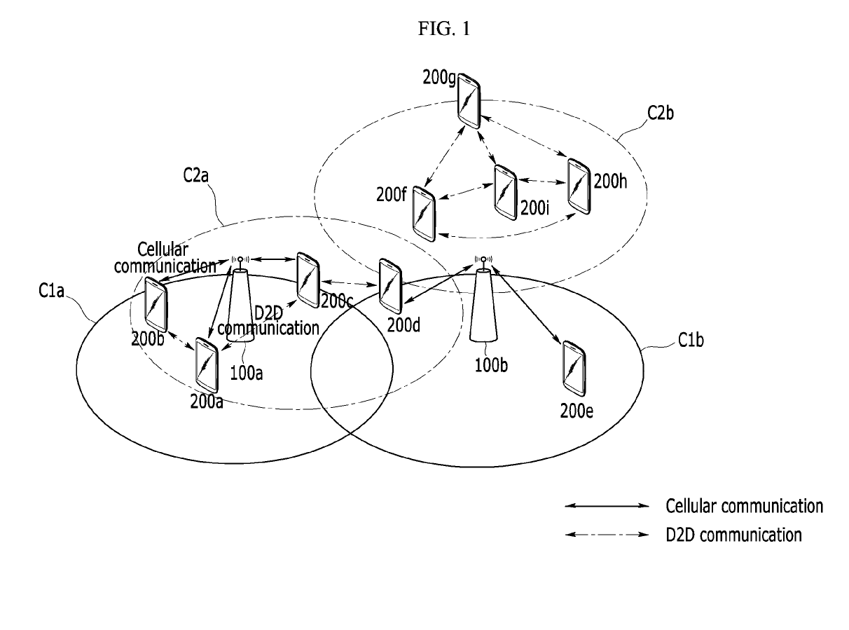

FIG. 1 is a diagram illustrating a basic communication environment for D2D communication.

Terminals 200a-200c placed in the coverage of the cell C1a of a base station 100a perform D2D communication under the control of the base station 100a. Furthermore, the terminal 200c may perform D2D communication with a terminal 200d placed within the coverage of the cell C1b of an adjacent base station 100b in the state in which a time offset is managed. That is, the terminal 200c may perform D2D communication with the terminals 200a, 200b, and 200d placed within its own D2D coverage C2a.

Each of the terminals 200a-200i may operate as a central control device if it has the function of the central control device. In this case, the function of the central control device includes a function for managing and allocating resources for D2D communication and a function for managing synchronization for D2D communication. FIG. 1 illustrates the case where the terminal 200i operates as a central control device, for convenience of description. The terminals 200f-200h placed out of the coverage of the cells C1a and C1b of the base stations 100a and 100b may perform D2D communication under the control of the central control device 200i. The central control device 200i may have D2D coverage C2b.

2. Distributed Management Method

A terminal needs to maintain a specific level of time synchronization in order to participate in D2D communication. The reason for this is that data can be transmitted and received only when the temporal locations of radio resources are the same between terminals that communicate with each other.

A terminal placed within coverage obtains the downlink synchronization of a base station using a synchronization signal broadcasted by a base station through downlink or using a control signal transmitted along with a data channel.

For D2D communication, a time synchronization procedure using a synchronization signal transmitted through an uplink band may be used. Particularly, a terminal placed at the boundary of a cell or out of coverage requires an additional synchronization procedure. A signal for uplink time synchronization may be broadcasted by a common terminal or may be broadcasted by a central control device that manages D2D communication synchronization. In this case, the central control device is a device for managing synchronization as described above, and transmits a synchronization signal or control information and a control signal for D2D communication. A terminal may perform the function of a central control device (e.g., Sync Tx UE or Sync Ref UE). To this end, a function for controlling D2D communication needs to be installed in the terminal. That is, a terminal may transmit a synchronization signal according to surrounding conditions. In this case, the terminal performs the function of a central control device. For convenience of description, a terminal that broadcasts a synchronization signal is hereinafter called a central control device. The central control device may be another device (i.e., a device different from a terminal) other than the terminal.

An operational procedure of a terminal in accordance with an exemplary embodiment of the present invention terminal is described below.

A terminal receives a downlink synchronization signal periodically broadcasted by a base station. When the terminal obtains the downlink synchronization signal, it performs a procedure for obtaining the synchronization and system information of the base station and performs an operational procedure within coverage.

The terminal searches for an uplink physical channel in order to receive a synchronization signal broadcasted by a central control device. More specifically, the terminal may first search for a frequency set because it has been previously used and may search for other frequencies according to order of priorities. With respect to the timing location of a synchronization signal, the terminal may first search for the downlink synchronization time of the base station and then search for surrounding timing, thereby reducing a search time.

The terminal searches for an uplink synchronization signal broadcasted by another terminal. If an uplink synchronization signal is not received, the terminal may perform the function of a central control device by directly transmitting an uplink synchronization signal.

A central control device that broadcasts an uplink synchronization signal may periodically continue to search for an uplink physical channel broadcasted by another central control device and may stop operating as the central control device if an uplink synchronization signal is obtained. More specifically, a terminal that belongs to terminals operating as central control devices and that has a higher priority maintains the transmission of an uplink synchronization signal. A terminal that has stopped a central control device operation may indicate (or include) information about the stop of the transmission of a synchronization signal or channel in a synchronization channel.

A physical channel used for the synchronization of a terminal may be divided into a synchronization signal and a synchronization channel.

The synchronization signal physically includes information that is required for a terminal to obtain synchronization. A central control device may broadcast a synchronization signal using a frequency division multiplexing (FDM) or code division multiplexing (CDM) method in order to distinguish the broadcasting from the transmission of another central control device. The location of the time resources of a synchronization signal is fixed and allocated in a constant cycle in an uplink band. More specifically, since interference is generated when a plurality of adjacent central control devices transmit synchronization signals, the central control devices may transmit the synchronization signals using different frequency resources or time resource locations or may include different information (e.g., using the scrambling of an LTE synchronization signal or a cell identifier) in the synchronization signals and broadcast the synchronization signals. Since a synchronization signal includes only some information that is necessary for a terminal to obtain synchronization, other additional information is broadcasted through a synchronization channel.

A synchronization channel includes pieces of information illustrated in Table 1 below. As a result, a synchronization channel has the function of a system information channel. Some of the pieces of information illustrated in Table 1 may be included in a synchronization signal so that a terminal can rapidly obtain the information.

TABLE 1

| INFOR- | |
|---|---|
| MATION | NOTES |
| Synchronization | Information indicative of a synchronization channel |
| channel | A synchronization channel including synchronization |
| indication | channel indication information may be broadcasted so that |
| information | it is distinguished by another terminal |
| Time | Timing information, such as system frame number (SFN) |
| information | information |
| Synchronization | Information about a synchronization signal mapped to a |
| signal | synchronization channel |
| information | |
| Standalone | Information indicative of a synchronization channel |
| information | broadcasted without the synchronization of a base station |
| | For example, synchronization acquisition using a GPS |
| Relay | Information indicative of a synchronization channel |
| information | broadcasted based on the synchronization of a base station |
| | Type information indicative of uplink synchronization or |
| | downlink synchronization in the case of a synchronization |
| | channel broadcasted based on the synchronization of a |
| | base station |
| | Differently indicate a device if the device broadcasts the |
| | synchronization of a surrounding central control device by |
| | relaying the synchronization |
| Accuracy | Accuracy of a synchronization signal |
| | For example, an error range or a hop count if the |
| | synchronization of a base station is relayed |
| Physical cell ID | Cell identifier of a base station used as a reference value |
| Central control | Identifier of a device that broadcasts a synchronization |
| device ID | signal |
| Mobility | Information indicating that a central control device is a |
| information | moving device or moving speed of a central control device |
| | (e.g., high speed, low speed, or fixed) |
| Time change | Change information about reference synchronization time |
| information | of a synchronization signal being transmitted by a device |
| | Offset between its own synchronization time and a change |
| | synchronization time, time to which a time change is |
| | applied (time when a time change is to be executed) |
| Location | Information about the location of a central control device |
| information | |
| Signal intensity | Signal intensity (strength) of a central control device |
| information | |
| Terminal | Information indicative of the presence of a cell |
| connection | (alternatively, a terminal or another central control device) |
| Information | using the synchronization signal of a central control device |
| | For example, the number of terminals using the |
| | synchronization signal of a central control device |
| End information | Information indicative of the end of the operation of a |
| | central control device |
| | Information about the stop and stop timing (e.g., an end |
| | after 5 seconds) of a synchronization signal |

A synchronization channel may further include information about the system of a cell broadcasted by an LTE base station. In this case, a communication parameter for D2D communication may be broadcasted through a synchronization channel. A terminal using the synchronization of a central control device performs D2D communication using a communication parameter included in a synchronization channel. The communication parameter included in the synchronization channel includes information (e.g., time/frequency resource information, a size, a cycle, and transmission power) about a channel used in D2D communication and information about the amount of availability of D2D communication channels.

A central control device periodically transmits a synchronization channel and may periodically change the location of a synchronization channel in order to avoid a collision against other channels. More specifically, a central control device changes the transmission location of a synchronization channel temporally (e.g., time division multiplexing (TDM)) so that it avoids a collision against a central control device that transmits a synchronization channel at the same location.

If a central control device transmits a synchronization channel, it receives a synchronization channel broadcasting area to which the central control device does not transmit a synchronization channel in a specific cycle and checks whether another central control device transmits a synchronization channel. If a central control device checks that a synchronization channel is transmitted by another central control device, it may stop the transmission of a synchronization signal and a synchronization channel in order to avoid a collision between the synchronization signals or may request another central control device to stop the transmission of the synchronization signal.

A central control device may broadcast control information similar to system information broadcasted by a base station through a synchronization channel. More specifically, the central control device may transmit information about the synchronization channel using the same procedure and channel structure as those of a data channel.

3. Need for Variable Cell Structure

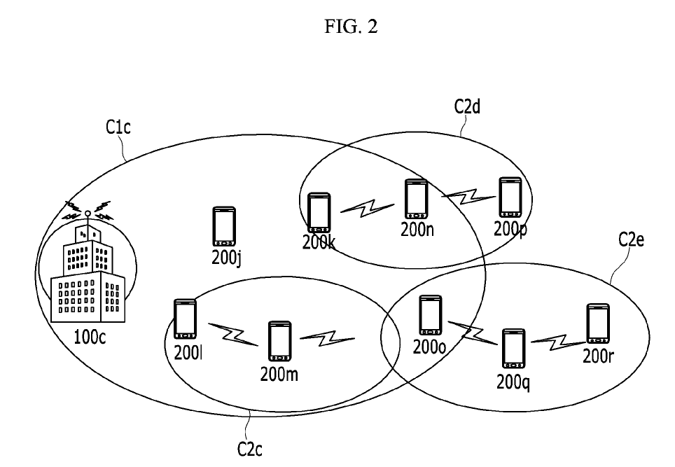

FIG. 2 is a diagram illustrating an environment in which terminals placed within the coverage of a base station perform D2D communication in synchronization with a central control device. FIG. 2 illustrates an example in which terminals 200m, 200n, and 200q operate as central control devices, for convenience of description. In this case, the terminals 200m, 200n, and 200q include respective D2D coverage C2c, C2d, and C2e. Furthermore, FIG. 2 illustrates the case where terminals 200j-200m are placed in the cell C1c of a base station 100c, the terminals 200n and 200o are placed at the boundary of the cell C1c, and the terminals 200p-200r are placed out of the radius of the cell C1c, for convenience of description.

The central control device 200m placed within the radius of the cell C1c of the base station 100c may obtain the synchronization of the base station 100c. If the central control device 200m transmits a synchronization signal and a related channel in line with the synchronization of the base station 100c, it does not generate interference with a channel transmitted/received by the cell C1c of the base station 100c. However, if the central control device 200m broadcasts its own synchronization signal without obtaining the synchronization of the base station 100c, a collision against the radio resources of the cell C1c of the base station 100c is generated, which serves as interference.

The central control device 200q placed out of the radius of the cell C1c of the base station 100c designates a specific time because it is unable to obtain the synchronization of the cell C1c of the base station 100c, broadcasts a synchronization signal, and transmits a related channel. In this case, since the central control device 200q does not maintain synchronization with the base station 100c, a collision against the uplink of the base station 100c is generated if the central control device 200q accesses the boundary of the cell C1c of the base station 100c. As a result, interference is generated.

Furthermore, the base station 100c and the central control device require a method (e.g., a variable cell structure whose transmission power intensity is changed) for solving interference generated by the central control device 2000 placed at the boundary of the cell C1c of the base station 100c because it is difficult to measure the interference.

4. Operation Method of Base Station

A method of controlling a base station in which a central control device that has not obtained the synchronization of the cell of the base station and that is placed out of a cell radius does not generate interference with the base station is described below.

A base station periodically broadcasts a downlink signal using downlink. More specifically, the base station periodically broadcasts a synchronization signal (e.g., a primary synchronization signal (PSS) or a secondary synchronization signal (SSS)) or system information channel. The base station may designate the intensity of a signal based on a specific reference value set by a higher system (e.g., an operations and management system) that supervises the operation of a mobile communication base station network and broadcast a synchronization signal or system information channel.

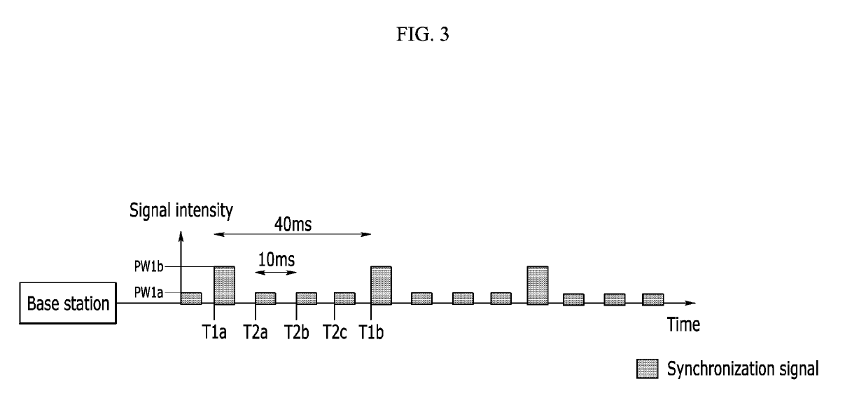

A base station may variably set the transmission power intensity of a downlink signal that is periodically broadcasted. More specifically, when broadcasting a downlink signal, such as a synchronization signal, a system information channel, or a control channel, the base station may set the intensity of transmission power as a value higher than a reference value and periodically transmit the downlink signal. In the remaining time, the base station may set the intensity of transmission power as the reference value and transmit the downlink signal. Accordingly, a central control device placed at the boundary of a cell can obtain information regarding whether a base station cell is present and information related to the synchronization of the base station cell. A method of variably setting the transmission power intensity of a downlink signal broadcasted by a base station over time is illustrated in FIG. 3.

FIG. 3 is a diagram illustrating a method of transmitting, by a base station, a signal in accordance with an exemplary embodiment of the present invention. FIG. 3 illustrates the case where a base station controls the transmission power intensity of a synchronization signal, for convenience of description.

For example, as illustrated in FIG. 3, a base station may set the transmission power intensity of a synchronization signal as a value PW1b higher than a reference value PW and broadcast the synchronization signal in a cycle of 40 ms (e.g., T1a and T1b). In the remaining time, the base station may set the transmission power intensity of the synchronization signal as a reference value TW1a and broadcast the synchronization signal in a cycle of 10 ms (e.g., T2a, T2b, and T2c).

Alternatively, the base station may designate the transmission power intensity in several steps (e.g., 2 steps or 3 steps). For example, the base station may broadcast the synchronization signal in a first cycle with the transmission power intensity of the reference value PW1a, may broadcast the synchronization signal in a second cycle longer than the first cycle with the transmission power intensity of the value PW1b, and may broadcast the synchronization signal in a third cycle longer than the second cycle with the transmission power intensity of the value PW1b. As the steps of transmission power intensity are various, the precision of the identification of a base station measured by a terminal or a central control device may be increased. For example, it is assumed that the base station controls the transmission power intensity of a downlink signal in three steps. If a central control device receives only a base station signal broadcasted in the third cycle, the central control device determines that it is placed at the boundary of the cell of the base station. If a central control device receives a base station signal broadcasted in the second cycle and a base station signal broadcasted in the third cycle, the central control device determines that it is placed at a location closer to the base station than to the boundary of the cell of the base station. If a central control device receives a base station signal broadcasted in the first cycle, a base station signal broadcasted in the second cycle, and a base station signal broadcasted in the third cycle, the central control device determines that it is placed at a location further close to the base station.

Alternatively, the base station may include a separate identifier (e.g., a base station identifier or a cell identifier) in a downlink signal broadcasted with transmission power intensity higher than the reference value PW1a. A terminal or a central control device may recognize the base station that broadcasts the downlink signal more easily through the identifier included in the downlink signal.

Alternatively, in order to provide the aforementioned function, a base station may configure a new control channel different from an existing downlink signal. More specifically, if a base station transmits a new control channel, it may variably set the transmission power intensity of the new control channel over time as described above. The new control channel may include a separate channel identifier or a signal (e.g., a PSS) for synchronization. A central control device may recognize that it has been placed at the boundary of a cell if it receives the signal, but does not receive an existing synchronization signal. A base station may not scramble the new control channel or may perform a small amount of scrambling on the new control channel so that many terminals receive the new control channel.

In order to check whether a base station is present or to obtain the synchronization of a base station, a central control device continues to search for a downlink signal (e.g., a synchronization signal or a new control channel) of the base station. If the central control device receives the downlink signal (e.g., a synchronization signal or a new control channel) of the base station, it checks whether the cell of the base station is present or obtains the downlink synchronization time of the base station using the received signal. If a base station broadcasts a signal with variable signal intensity using an existing synchronization signal, a central control device needs to check whether the corresponding signal is a signal for preventing interference when it receives the synchronization signal of the base station. To this end, the central control device determines that it is placed at the boundary of the cell of the base station if the received signal (e.g., a synchronization signal or a new control channel) is received in a cycle (e.g., 40 ms) longer than a common cycle (e.g., 10 ms) and recognizes that its current location is a location where the uplink signal of a terminal is difficult to reach the base station. A ground (e.g., a common cycle value or a long cycle value) for determining whether the cycle of a received signal is a common cycle or a long cycle may be preconfigured and stored in the mobile communication operation information of a terminal. If a terminal playing the role of a central control device determines that it is placed at the boundary of the cell of a base station, the terminal may wait until it receives a synchronization signal of a common cycle without attempting to access the base station in order to prevent interference. In a structure in which a base station sets transmission power intensity in many steps (e.g., 3 steps) and transmits a signal, a central control device may predict the distance between the central control device and the base station more accurately as described above.

If a central control device is able to receive a synchronization signal of a common cycle from a base station although it is placed at the boundary of the cell of the base station, the central control device may operate without affecting interference with the uplink of the cell of the base station by transmitting a signal and a channel in line with the synchronization of the base station.

If a central control device receives the downlink signal (e.g., a synchronization signal or a new control channel) of the base station, however, it can reduce interference with the cell of the base station cell by stopping the broadcasting of its own synchronization signal or lowering the transmission power intensity of the synchronization signal.

A moving cell performs the same function as the cell of a mobile communication base station. A moving cell node (or apparatus) including a moving cell has mobility and may easily designate the location of the moving cell using wireless backhaul. A moving cell functions to receive a signal broadcasted by a surrounding base station cell or surrounding moving cell for an operation with the surrounding base station cell or surrounding moving cell. A moving cell node performs an operation for searching for a base station using the same procedures as the central control device and being synchronized with the base station when it receives the synchronization signal of the base station. A moving cell node may perform the same or similar operation as a central control device described in this specification.

5. Operation Method of Central Control Device

A method of controlling a central control device in which the central control device that has not obtained the synchronization of a base station and that has been placed out of the coverage of the base station does not generate interference with the cell of the base station is described below.

A central control device variably sets the transmission power intensity of an uplink signal (e.g., a synchronization signal) when broadcasting the uplink signal (e.g., a synchronization signal). More specifically, the central control device increases the transmission power intensity of an uplink signal (e.g., a synchronization signal) over time starting from a low value. That is, the central control device sets the transmission power intensity of an uplink signal as a low value when starting broadcasting the uplink signal (e.g., a synchronization signal). If the central control device does not receive a surrounding transmission signal or control message, it may continue to increase the transmission power intensity of an uplink signal up to a predetermined value. Accordingly, the central control device broadcasts the uplink signal so that a neighbor cell or central control device is not subject to interference. Furthermore, when starting broadcasting the uplink signal (e.g., a synchronization signal), the central control device may set the transmission cycle of the uplink signal as a long cycle and reduce the transmission cycle of the uplink signal over time.

When a central control device accesses a base station, such signal intensity (e.g., a low value of transmission power intensity, a variable size, maximum transmission power intensity, and a transmission cycle) may be set in the central control device through the control message of the base station.

A central control device continues to search for the synchronization signal of a surrounding cell or surrounding central control device when broadcasting a synchronization signal. If a central control device receives the signal (e.g., a synchronization signal) of a surrounding cell, the signal of a surrounding terminal, or the signal (e.g., a synchronization signal) of a surrounding central control device when transmitting a synchronization signal, it avoids interference by maintaining or lowering the transmission power intensity of the synchronization signal. Alternatively, if a central control device receives a surrounding synchronization signal and obtains synchronization from the received synchronization signal, it may be synchronized with the received synchronization signal. In this case, the central control device may maintain the transmission of its own signal without change or may set the transmission power intensity of the synchronization signal as a higher value. If the central control device has changed its synchronization according to the received synchronization signal, it may notify a surrounding terminal of a change of synchronization channel information by changing the synchronization channel information. Alternatively, if a central control device receives a surrounding synchronization signal, it may stop the broadcasting of a synchronization signal.

If a central control device broadcasts a signal (e.g., a synchronization signal), it may use the aforementioned method of transmitting, by a base station, a signal described in “4. Operating method of base station.”

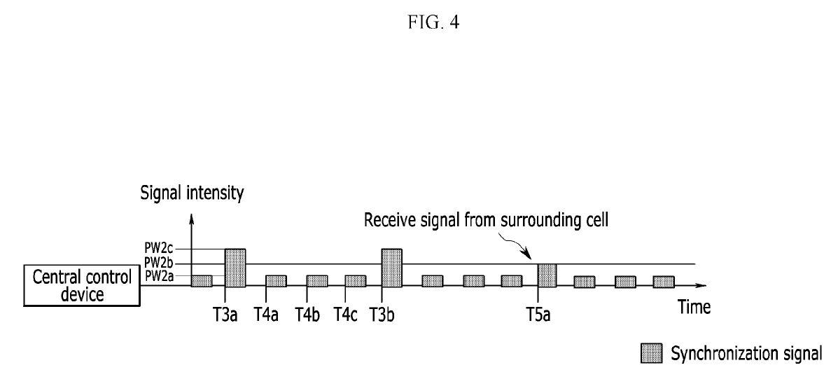

In this case, the central control device may measure whether another central control device is present or the proximity state of another central control device and may reduce interference between the central control devices by controlling its own transmission power intensity. A method of variably setting the transmission power intensity of a signal broadcasted by a central control device is illustrated in FIG. 4.

FIG. 4 is a diagram illustrating a method of transmitting, by a central control device, a signal in accordance with an exemplary embodiment of the present invention. FIG. 4 illustrates the case where a central control device controls the transmission power intensity of a synchronization signal, for convenience of description.

For example, as illustrated in FIG. 4, a central control device may set the transmission power intensity of a synchronization signal as a value PW2c higher than a reference value PW2a and then broadcast the synchronization signal in a long cycle (e.g., T3a and T3b). In the remaining time, the central control device may set the transmission power intensity of the synchronization signal as the reference value TW2a and then broadcast the synchronization signal in a short cycle (e.g., T4a, T4b, and T4c). If the central control device receives the signal (e.g., a synchronization signal) of a surrounding cell, the signal of a surrounding terminal, or the signal (e.g., a synchronization signal) of a surrounding central control device at a point of time T5a, it may lower the transmission power intensity of the synchronization signal from the value PW2c to a value PW2b and transmit the synchronization signal.

Like the central control device, a base station or a moving cell may also variably set the transmission power intensity of a synchronization signal or system information channel when it transmits the synchronization signal or system information channel.

6. Operation Method of Surrounding Terminal

An operation method of a surrounding terminal in which support is provided to a central control device that has not obtained the synchronization of a base station and that has been placed out of the cell radius of the base station so that the central control device does not generate interference with the cell of the base station is described below. In this case, the surrounding terminal means a terminal that has been placed between the base station and the central control device out of the cell radius and that is able to receive signals from the base station and the central control device. “6. Operation method of surrounding terminal” is an operation method applied when a central control device is placed at the boundary of a base station and is unable to access the base station.

A surrounding terminal continues to receive the downlink synchronization signal of a base station and performs a procedure for obtaining the synchronization of the base station or attempting to access the base station. Furthermore, the surrounding terminal continues to receive a surrounding uplink synchronization signal and performs a synchronization setting operation with a central control device.

A terminal placed within a cell radius obtains the synchronization of a base station and operates. If a terminal placed within a cell radius receives the synchronization signal of a surrounding central control device, it obtains information about the central control device that transmits the received synchronization signal or a control channel related to the received synchronization signal. The terminal that has obtained information about the central control device may transmit control information to the central control device so that the central control device changes a synchronization reference time. That is, if the terminal determines that the time synchronization of the central control device has deviated from the synchronization signal of the base station by a specific range, it may transmit control information to the central control device so that the synchronization time of the central control device is changed. In this case, the control information may include cell identification information, time information, or an SFN. More specifically, the time information included in the control information is indicative of an offset between the synchronization time of the base station and the synchronization time of the central control device. The central control device that has received the time information changes its synchronization time by a corresponding time. Furthermore, the control information may include (or relay) some of the system information of the base station. A terminal may transmit control information in a specific cycle once or repeatedly, and may not retransmit the control information to a central control device to which the control information has been previously transmitted after transmitting a specific number of the control information in order to reduce the transmission of the control information.

In order to transmit control information, a terminal may use a random access channel or use a new physical channel for D2D communication including the control information. After transmitting the random access channel or the new physical channel for D2D communication, the terminal may transfer the control information through a data channel.

A central control device that has received control information from a terminal may stop the transmission of a synchronization signal or a related channel or reduce the transmission power intensity of the synchronization signal or related channel. Alternatively, the central control device may change its own synchronization time to the synchronization time of a cell. If the central control device changes the synchronization time, it may transmit synchronization time change information in order to maintain the communication of terminals that use the synchronization channel of the central control device. More specifically, the central control device may include the synchronization time change information in the synchronization channel and broadcast the synchronization channel or may include the synchronization time change information in a separate control channel and broadcast the separate control channel.

If a terminal placed within a cell radius identifies the synchronization signal of a surrounding central control device, it may report information about the surrounding central control device to a base station. More specifically, the terminal may report the synchronization time of the central control device, identification information (terminal identification information), signal intensity, relay information, or the number of terminals connected to the central control device to the base station. The base station may change the synchronization time of the central control device and signal intensity using the reported information.

A base station may instruct a terminal in an idle state to shift to a connected state so that the terminal is able to report information about a central control device. Alternatively, a terminal in an idle state may directly shift to a connected state without an instruction from a base station. Further alternatively, in order to reduce signaling in an environment including many terminals, only a terminal in a connected state may report information about a central control device to a base station, and a base station may also instruct only a terminal in a connected state to perform measurement or a report.

A moving cell may perform the function and operation of a base station or a central control device described “6. Operation method of surrounding terminal.”

7. Operation Method of Terminal that has Obtained Synchronization of Central Control Device

There may be problems in that power consumption occurs and interference is generated nearby because a central control device continues to transmit a synchronization signal. In order to solve the problems, a central control device may stop the transmission of a synchronization signal when the broadcasting of the synchronization signal is not required and use surrounding terminal information in order to support such an operation. To this end, a terminal that has received the synchronization signal of a central control device and that has obtained the synchronization of the central control device may communicate with the central control device. When a surrounding terminal receives the synchronization signal of a central control device, it may transmit a signal indicative of its own state to the central control device. More specifically, the terminal notifies the central control device that it uses the synchronization signal of the central control device. The central control device continues to operate if a terminal using the synchronization of the central control device is present and stops the broadcasting of the synchronization signal or reduces the intensity of the synchronization signal if a terminal using the synchronization of the central control device is not present.

A central control device may include the number or identification information of terminals connected thereto in a synchronization channel and transmit the synchronization channel. Furthermore, if the central control device does not receive a surrounding transmission signal or control message while continuing to transmit the synchronization signal, it may continue to increase the transmission power intensity of the synchronization signal or channel up to a set value and transmit the synchronization signal or channel. In this case, the provision of synchronization information to terminals is expanded because the coverage of the central control device is increased.

In order to notify a central control device of synchronization acquisition information, a terminal may use uplink radio resources and use a method similar to a procedure using a random access channel. More specifically, when the terminal obtains the synchronization of the central control device, it transmits a physical channel or a high layer (e.g., medium access control (MAC) or radio resource control (RRC)) message using a radio resource area indicated by the central control device through a synchronization channel. In this case, the synchronization acquisition information transmitted by the terminal may include information about whether the terminal has accessed a base station, information about a base station accessed by the terminal, information about whether a central control device accessed by the terminal is present, or the number of central control devices accessed by the terminal.

A central control device may predict whether a terminal using the synchronization signal of the central control device is present or the number of terminals using the synchronization signal of the central control device, the distance between the central control device and a terminal using the synchronization signal of the central control device, or the number of terminals that have obtained only one synchronization or information about the terminals based on the synchronization acquisition information received from a terminal.

8. Signaling Between Base Station and Central Control Device

If a central control device is placed within the cell radius of a base station and is able to communicate with the base station, the base station may set the transmission intensity or transmission cycle of the synchronization signal of the central control device. In this case, the base station includes a moving cell node (or device) having a moving cell.

A base station determines a need for a central control device. If a central control device is required, the base station may instruct a surrounding terminal to operate as a central control device and to broadcast a synchronization signal.

More specifically, if a first terminal that has accessed a base station is placed at the boundary of a cell or deviates from a cell radius, the base station may instruct a second terminal to operate as a central control device. For example, if a base station recognizes that the signal of a first terminal moving from the boundary of a cell is reduced, the base station may instruct a second terminal to operate as a central control device and to broadcast a synchronization signal. Furthermore, if a neighbor cell has not been constructed nearby, the base station may instruct a surrounding terminal to operate as a central control device. For example, if a terminal is placed in an area in which a cell has not been disposed according to a base station construction structure, a base station may instruct a surrounding terminal to operate as a central control device and to broadcast a synchronization signal. Furthermore, if a terminal requests a need for a central control device from a base station, the base station may instruct a surrounding terminal to operate as the central control device. For example, if a terminal requests a need for a synchronization signal from a base station, the base station may instruct a surrounding terminal to operate as a central control device and to broadcast the synchronization signal.

The transmission/reception of a message for instructing a terminal to operate as a central control device is required, and a procedure thereof is as follows. More specifically, a base station requests a surrounding terminal to check whether the surrounding terminal may operate as a central control device. For example, the base station may transmit a check request message through a paging channel, a broadcasting channel, or a data channel. The terminal that has received the check request message transmits a response indicating whether it may operate as a central control device. For example, the terminal may include (or indicate) its own mobility, signal intensity, power state, and location information in a response message and transmit the response message to the base station. A terminal that does not satisfy a condition does not respond. The base station that has received the response message instructs the terminal that has sent the response message to operate as a central control device. For example, the base station may check the condition, may select at least one of terminals that have sent response messages, and may transmit an indication message to the selected terminal. The terminal that has received the indication message performs the function of a central control device. The terminal may transmit a response message for the indication message to the base station.

9. Inter-Cell Problem: When a Central Control Device Accesses a Plurality of Cells

If a central control device moves to the boundary of a cell, it may be placed in a plurality of the boundaries of cells. If the central control device has already been synchronized with one cell, it may generate interference with the remaining cells.

When a central control device synchronized with one cell receives the synchronization signal of the other cell, it determines the intensity of the synchronization signal of the other cell. If the intensity of the synchronization signal of the other cell is a predetermined reference value or higher, the central control device changes its synchronization time to the synchronization time of the other cell. Furthermore, the central control device whose synchronization time has been changed changes information about a synchronization channel and transmits the changed information so that a terminal using the synchronization of the central control device changes information.

A central control device that has received the synchronization signals of a plurality of base station cells may stop the broadcasting of its own synchronization signal or reduce the transmission power intensity of a signal in order to reduce interference. In this case, the central control device may check the state of a terminal using the synchronization signal of the central control device and may stop the broadcasting of the synchronization signal or reduce the transmission power intensity of the signal based on a result of the check. More specifically, the central control device may stop the broadcasting of the synchronization signal or reduce the transmission power intensity of the signal based on the number of terminals using the synchronization signal of the central control device or information about the number of terminals that have obtained only the synchronization signal of the central control device.

10. Operation of Cell Access Reference Value of Terminal: Conservative Connection Management Terminal

A terminal differently performs an access operation depending on the measured intensity of a cell and the access state of a terminal. More specifically, if a terminal is placed out of a cell radius and then moves to the boundary of a cell, the terminal may set the signal intensity reference value for cell access (hereinafter called a “cell access reference value”) as a low value and then perform a procedure for accessing a measurement base station or a measurement cell. Since the cell access reference value is set as a low value, the terminal may access the cell more easily.

Furthermore, a terminal that is accessing one cell (i.e., a terminal placed within a cell radius) may set a cell access reference value as a high value. Since the cell access reference value is set as a high value, the terminal may change an access cell more difficulty (or slowly).

To this end, a terminal or a central control device may use a plurality of cell access reference values. More specifically, when accessing a base station, a terminal or a central control device may receive a plurality of cell access reference values from a high layer. In this specification, the access state includes the connected state of a terminal and the idle state of a terminal, and further includes the state in which a terminal in the idle state has obtained synchronization by receiving a signal from a single base station.

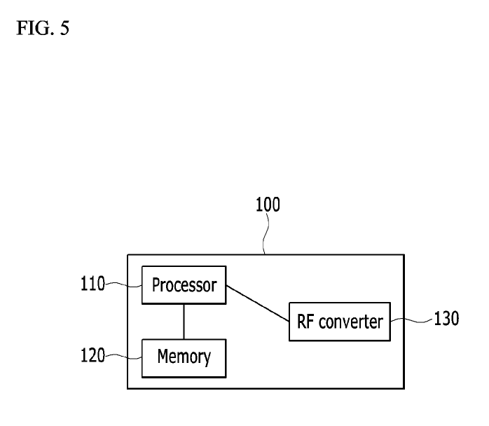

FIG. 5 is a diagram illustrating the configuration of a base station 100 in accordance with an exemplary embodiment of the present invention.

The base station 100 includes a processor 110, memory 120, and a radio frequency (RF) converter 130.

The processor 110 may be configured to implement the functions, procedures, and methods described in this specification and related to the base station.

The memory 120 is connected to the processor 110, and stores various information related to the operation of the processor 110.

The RF converter 130 is connected to the processor 110, and transmits or receives radio signals. Furthermore, the base station 100 may have a single antenna or multiple antennas.

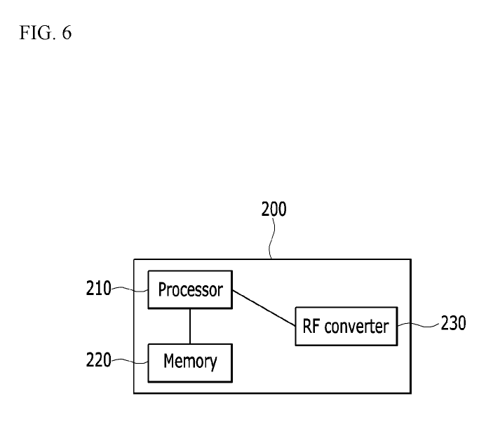

FIG. 6 is a diagram illustrating the configuration of a terminal 200 in accordance with an exemplary embodiment of the present invention.

The terminal 200 includes a processor 210, memory 220, and an RF converter 230.

The processor 210 may be configured to implement the functions, procedures, and methods described in this specification and related to the terminal. Alternatively, the processor 210 may be configured to implement the functions, procedures, and methods described in this specification and related to the central control device.

The memory 220 is connected to the processor 210, and stores various information related to the operation of the processor 210.

The RF converter 230 is connected to the processor 210, and transmits or receives radio signals. Furthermore, the terminal 200 may have a single antenna or multiple antennas.

A licensed band may be used in D2D communication in accordance with an exemplary embodiment of the present invention.

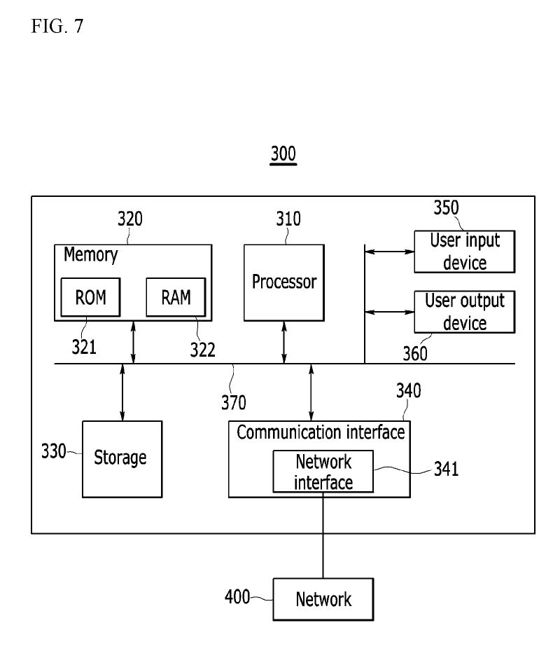

An exemplary embodiment of the present invention may be implemented in a computer system (e.g., a computer-readable medium). As illustrated in FIG. 7, the computer system 300 may include at least one processor 310, at least one piece of memory 320, and at least one piece of storage 330. Furthermore, the computer system 300 may further include a communication interface 340. The communication interface 340 may include a network interface 341 connected to a network 400. Furthermore, the computer system 300 may further include a user input device 350 and a user output device 360. The elements 310-360 may perform communication through a bus 370.

The processor 310 may be a central processing unit (CPU) or semiconductor device for executing processing instructions stored in the memory 320 or the storage 330. The memory 320 and the storage 330 may include various types of volatile or non-volatile storage media. For example, the memory 320 may include read-only memory (ROM) 321 and random access memory (RAM) 322.

Accordingly, an exemplary embodiment of the present invention may be implemented using a non-transitory computer-readable medium in which computer-executable instructions have been stored.

In an exemplary embodiment of the present invention, if the computer-executable instructions are executed by the processor 310, they may perform a method according to at least one aspect of the present invention.

In accordance with an exemplary embodiment of the present invention, since a base station variably sets the transmission power intensity of a signal and broadcasts the signal, a central control device can precisely predict the distance between it and the base station and control the broadcasting of its own signal based on the distance from the base station. Accordingly, D2D communication can be supported while interference with a mobile communication system is not generated.

Furthermore, in accordance with an exemplary embodiment of the present invention, a terminal can perform D2D communication in synchronization with a base station or a central control device. Furthermore, in accordance with an exemplary embodiment of the present invention, terminals participating in D2D communication can set time and frequency synchronization.

Furthermore, in accordance with an exemplary embodiment of the present invention, a terminal can perform D2D communication in which the terminal is controlled by a mobile communication base station. Furthermore, in accordance with an exemplary embodiment of the present invention, a terminal can perform D2D communication through a central control device if it is placed at the boundary of a cell or out of the boundary of the cell.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmission/reception method of a base station in a device to device (D2D) communication environment in which terminals directly communicate with each other, comprising:
variably setting transmission power intensity of a downlink signal over time; and
broadcasting the downlink signal with the set transmission power intensity.

2. The transmission/reception method of claim 1, wherein variably setting the transmission power intensity comprises:
setting the transmission power intensity of the downlink signal as a first value at a first point of time having a predetermined cycle; and
setting the transmission power intensity of the downlink signal as a second value greater than the first value at a second point of time having a longer cycle than the first point of time, and
broadcasting the downlink signal comprises:
broadcasting the downlink signal at the first point of time; and
broadcasting the downlink signal at the second point of time.

3. The transmission/reception method of claim 2, wherein broadcasting the downlink signal at the second point of time comprises including an identifier indicative of the base station in the downlink signal.

4. The transmission/reception method of claim 1, wherein the downlink signal comprises at least one of synchronization information, system information, and control information.

5. The transmission/reception method of claim 1, further comprising:
instructing a first terminal to change a state to a connected state of an idle state and the connected state when the first terminal receives information about a second terminal operating as a central control device for managing synchronization and resources for the D2D communication; and
receiving the information about the second terminal from the first terminal in the connected state,
wherein the information about the second terminal comprises information about a synchronization time of the second terminal, a terminal identifier of the second terminal, and a number of terminals connected to the second terminal.

6. The transmission/reception method of claim 1, further comprising setting transmission power intensity and a transmission cycle of a synchronization signal transmitted by a first terminal operating as a central control device for managing synchronization and resources for the D2D communication when the first terminal is placed in a cell of the base station.

7. A device to device (D2D) communication method in which a first terminal directly communicates with another terminal, comprising:
broadcasting a first synchronization signal when the first terminal operates as a central control device for managing synchronization and resources for D2D communication;
determining a cycle in which a downlink signal is transmitted when the downlink signal is received from a base station; and
controlling the broadcasting of the first synchronization signal based on the transmission cycle of the downlink signal.

8. The D2D communication method of claim 7, wherein controlling the broadcasting of the first synchronization signal comprises:
determining that the first terminal is placed at a boundary of a cell of the base station when the transmission cycle of the downlink signal is longer than a reference cycle; and
stopping the broadcasting of the first synchronization signal or reducing transmission power intensity of the first synchronization signal when the first terminal is placed at the boundary of the cell of the base station.

9. The D2D communication method of claim 7, wherein
the downlink signal comprises a second synchronization signal broadcasted by the base station, and
controlling the broadcasting of the first synchronization signal comprises changing a synchronization time for the broadcasting of the first synchronization signal based on the second synchronization signal when the transmission cycle of the downlink signal is longer than a reference cycle.

10. The D2D communication method of claim 7, wherein broadcasting the first synchronization signal comprises increasing transmission power intensity of the first synchronization signal and shortening a transmission cycle of the first synchronization signal over time.

11. The D2D communication method of claim 7, further comprising decreasing transmission power intensity of the first synchronization signal or changing a synchronization time of the first synchronization signal based on a third synchronization signal when the third synchronization signal is received from a cell adjacent to the first terminal or a central control device adjacent to the first terminal.

12. The D2D communication method of claim 11, wherein changing the synchronization time of the first synchronization signal comprises:
determining reception intensity of the third synchronization signal; and
changing the synchronization time of the first synchronization signal based on the third synchronization signal when the reception intensity of the third synchronization signal is greater than a reference value.

13. The D2D communication method of claim 7, further comprising:
receiving control information comprising information about a difference between a synchronization time of a first cell and a synchronization time of the first terminal from a second terminal placed within the first cell of the base station; and
stopping the broadcasting of the first synchronization signal, reducing transmission power intensity of the first synchronization signal, or changing a synchronization time of the first synchronization signal based on the control information.

14. The D2D communication method of claim 13, further comprising broadcasting a first synchronization channel comprising synchronization time change information when the synchronization time of the first synchronization signal is changed.

15. The D2D communication method of claim 14, wherein the first synchronization channel comprises:
information about the first synchronization signal corresponding to the first synchronization channel;
information about resources for the D2D communication; and
information about a number of terminals using the first synchronization signal.

16. The D2D communication method of claim 7, wherein broadcasting the first synchronization signal comprises:
receiving a request message for checking whether the first terminal is able to operate as a central control device from the base station;
transmitting a response message comprising at least one of pieces of information about mobility, signal intensity, power state, and location of the first terminal to the base station; and
operating as a central control device when an indication message is received from the base station.

17. The D2D communication method of claim 7, further comprising:
setting a signal intensity reference value for cell access as a first value when the first terminal is placed at a boundary of a cell of the base station; and
setting the signal intensity reference value as a second value greater than the first value when the first terminal is placed in the cell of the base station.

18. A device to device (D2D) communication method in which a first terminal directly communicates with another terminal, comprising:
receiving a first synchronization signal and a first synchronization channel from a first central control device which manages synchronization and resources for the D2D communication and is different from a base station;
obtaining the synchronization for the D2D communication from the first synchronization signal and obtaining the resources for the D2D communication from the first synchronization channel; and
transmitting synchronization acquisition information to the first central control device using the resources for the D2D communication.

19. The D2D communication method of claim 18, wherein transmitting the synchronization acquisition information comprises transmitting the synchronization acquisition information comprising a number of central control devices accessed by the first terminal to the first central control device through at least one of a physical channel, a medium access control (MAC) message, and a radio resource control (RRC) message.

20. The D2D communication method of claim 18, further comprising transmitting information about a synchronization time of the first central control device, information about signal intensity of the first central control device, and information about a number of terminals connected to the first central control device to the base station when the first terminal is placed in a cell of the base station.
